(19) United States
(12) Patent Application Publication
(10) Pub. No.: US 2007/0013290 A1
(43) Pub. Date: Jan. 18, 2007

(54) Closed ring structure of electrostatic discharge circuitry

(75) Inventors: Ming-Dou Ker, Hsin-Chu City (TW); Chien-Ming Lee, Taidong City (TW)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(73) Assignee: Silicon Integrated Systems Corp.

(21) Appl. No.: 11/332,415

(22) Filed: Jan. 13, 2006

(30) Foreign Application Priority Data
Jul. 15, 2005 (TW) 94124123

(51) Int. Cl. H01J 1/62

(52) U.S. Cl. 313/498

(57) ABSTRACT

An electrostatic discharge (ESD) circuitry bus within closed ring is disclosed. The closed ring comprises a plurality of metal layer. A metal layer can conduct electricity to another metal layer by conductive plugs. An oxide region can separate the closed ring into two closed ring regions by payout. Each closed ring region does not conduct electricity to each other by an oxide region. One closed ring section is Vdd bus. Therefore, the closed ring of the present invention can be sued by Vss bus and Vdd bus at the same time.

### BACKGROUND OF THE INVENTION

1. Field of the Invention

The present invention relates to a closed ring structure of electrostatic discharge circuitry, and more particularly relates to a closed ring structure for being used by the Vss bus and Vdd bus at the same time.

2. Description of the Prior Art

There are some electrostatic discharge circuitries (ESD) in most applications of the integrated circuit. The circuitry can be used to absorb and release the static electricity with high voltage, which can damage circuit. One of the electrostatic discharge circuitry is an input/output (I/O) unit. The functions of the I/O unit are: the signal can be used in the core of the circuit region from the I/O pad, and the I/O unit is also used to amplify and activate the signal, which is from the internal of the core circuit to the external of the IO pad. And the I/O pad can be connected to the wire of the packaging component.

Generally, the static electricity controlled and moved by the human is about 2000 voltages (just like the current with 1.3A flowing through 1500(ohm)) and most of the electrostatic discharge circuitry can release and absorb enough static electricity, which can cause the static electricity discharge.

The prior art is related to the present invention, referring to U.S. Pat. No. 6,078,068, and the patent provides an integrated circuit with electrostatic discharge protect structure. Referring to FIG. 1 is a vertical view of the semiconductor die, the die of the integrated circuit is included a core logic region with a plurality of transistors. The transistors are connected to each other and formed a specific integrated circuit. A plurality of input/output cells 106 are limited in the surrounding area of the die of the integrated circuit. The prior art is provided a ESD bus die edge seal 120, which: is disposed in the outside of a plurality of input/output cells 106. The input/output cells 106 are closely connected to the outside the die of the integrated circuit. The external part of the input/output cell 106 is included a plurality of Vss power cells. A plurality of ESD cross-coupled diodes 110 are connected between a plurality of Vss power cells and ESD bus die edge seal. And a sealed structure is provided in the united closed ring structure of the ESD circuitry of the die.

The semiconductor die described above is included a bonding pad 108 and ESD bus die edge seal 120. The ESD bus die edge seal 120 is coupled to the chosen input/output cell 106 by the ESD cross coupled diode 110. The outside of the ESD bus die edge seal 120 is the oxidized surface 104a of the first circle. The inside of the ESD bus die edge seal 120 is the oxidized surface 104b of the second circle. In order to provide an efficient electric depletion path to prevent causing a high voltage ESD in the production, packaging, or the components in shipping, all the Vss cells are connected to the ESD bus die edge seal 120.

FIG. 2 is a cross-sectional view of the semiconductor die seal in the prior art. And comparing to FIG. 1, the ESD bus die edge seal 120 comprises a first metal layer 21, the second metal layer 22, the third metal layer 23, the forth metal layer 24, the fifth metal layer 25 and the sixth metal layer 26. The oxidized layer used to be the obstruction and the seal structure in the surrounding area of the semiconductor die is filled between each metal layer. There is a P-substrate in the bottom of the semiconductor die. And the P-substrate comprises a doped region, which is a P+ substrate contact.

The first metal layer 21 is electrically connected to the P+ substrate contact by the conductive contact 21a and the conductive contact 21b. The first metal layer 21 is electrically connected to the second metal layer 22 by the conductive plug 22a and the conductive plug 22b. The second metal layer 22 is electrically connected to the third metal layer 23 by the conductive plug 23a and the conductive plug 23b. The third metal layer 23 is electrically connected to the forth metal layer 24 by the conductive plug 24a and the conductive plug 24b. The forth metal layer 24 is electrically connected to the fifth metal layer 25 by the conductive plug 25a, and the conductive plug 25b. The fifth metal layer 25 is electrically connected to the sixth metal layer 26 by the conductive plug 26a and the conductive plug 26b. The metal layers of the ESD bus die edge cell can be electrically connected to each other by the conductive plugs. The electric charge moving from the die edge 204 can be attracted by the Vss power supply, which is provided by the ESD cross coupled diode 210. And the width W2 of the ESD bus die edge seal 120 is about 4 μm˜40 μm. For the 0.35 mm conduction, the width W2 of the seal is about 6 μm˜30 μm.

Because the seal of the prior art can only be used to be the ESD Vss electrostatic discharge bus, it is not a good way to use the seal structure to decrease the size of the die and the cost of the production.

### SUMMARY OF THE INVENTION

The purpose of the present invention is to overcome the drawbacks described above, and a new structure provided to let the seal be used by the Vss bus and the Vdd bus at the same time. Therefore, the size of the die can be decreased.

The present invention provides a new structure to let the seal be used by the Vss bus and Vdd bus at the same time and then the cost can be reduced.

The present invent provides a new electrostatic discharge (ESD) circuitry bus within the closed ring structure. The closed ring includes a plurality of metal layers. The oxidized layer is used to divide each of the metal layers. The metal layers can be electrically connected to each other by the conductive plug. By the layout, the oxidized layer can be used to divide the closed ring into two closed ring regions, which are not electrically connected to each other. One of the two closed ring regions is the Vss electrostatic discharge bus, and the other is the Vdd electrostatic discharge bus. Therefore, the closed ring structure of the present invention can be used by the Vss bus and the Vdd bus at the same time.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is vertical view of the semiconductor die.

FIG. 2 is a cross-sectional view of the closed ring structure in the semiconductor of the prior art.

FIG. 3 is a cross-sectional view of the closed ring structure according to the first embodiment of the present invention.

FIG. 4 is a cross-sectional view of the closed ring structure according to the second embodiment of the present invention.

FIG. 5 is a cross-sectional view of the closed ring structure according to the third embodiment of the present invention.

FIG. 6 is a cross-sectional view of the closed ring structure according to the forth embodiment of the present invention.

FIG. 7A is a vertical view of the third metal layer according to the fifth embodiment of the present invention.

FIG. 7B is the first cross-sectional view of the closed ring structure according the fifth embodiment of the present invention.

FIG. 7C is the second cross-sectional view of the closed ring structure according to the fifth embodiment of the present invention.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

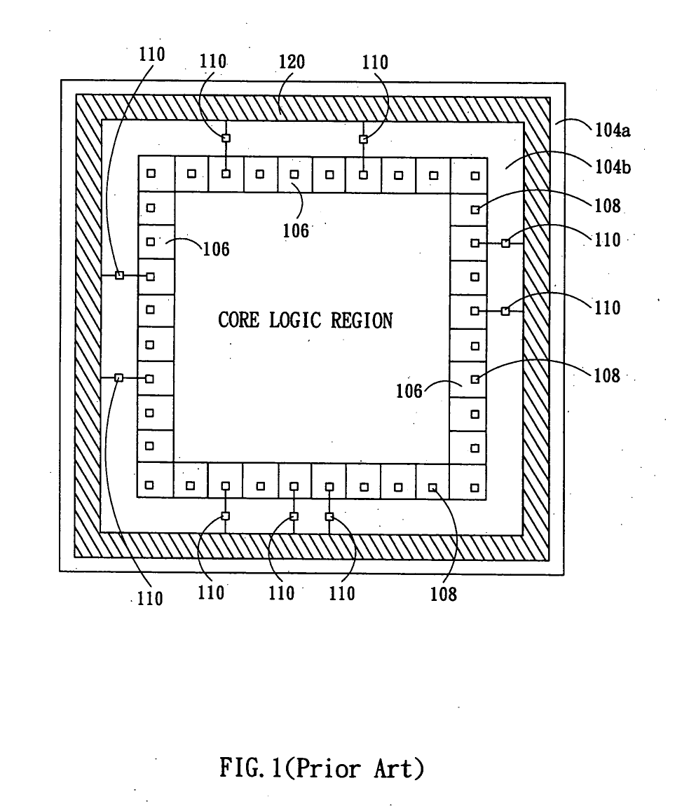

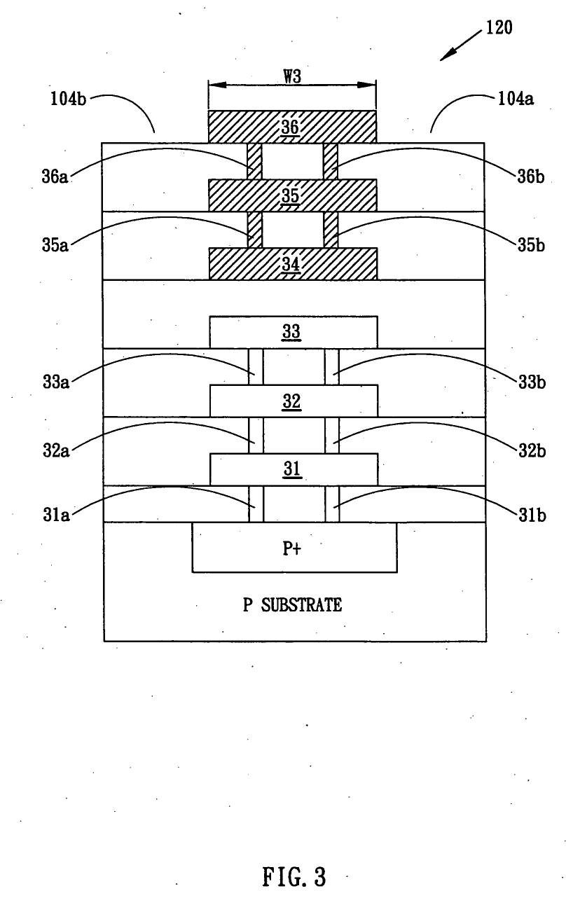

FIG. 3 is the vertical view of the closed ring structure in the first embodiment of the present invention. And comparing with the FIG. 1A and FIG. 3, the closed ring 120 includes a first metal layer 31, a second metal layer 32, a third metal layer 33, a forth metal layer 34, a fifth metal layer 35, a sixth metal layer 36 and all the metal layers are isolated by the oxidized layer. The right side of the sixth metal layer 36 is the oxidized layer surface 104a of the first circle and the right side of which is the oxidized layer surface 104b of the second circle. The bottom of the closed ring 120 is a P substrate. And the P substrate is included a doped region, which is the P+ substrate contact.

The conductive contact 31a and the conductive contact 31b are used to connect between the first metal layer 61 and the P+ substrate contact. The conductive plug 32a and the conductive plug 32b are used to connect between the first metal layer 31 and the second metal layer 33. The oxidized is used to electrically isolate the region between the third metal layer 33 and the forth metal layer 34. The conductive plug 35a and the conductive plug 35b are used to connect between the forth metal layer 34 and the fifth metal layer 35 the conductive plug 36a and the conductive plug 36b are sued to connect between the fifth metal layer 35 and the sixth metal layer 36.

According to FIG. 3, there are no conductive plugs can be used to electrically connect between the third metal layer 33 and the forth metal layer 34. The region below the third metal layer 33 is the Vss electrostatic discharge bus and the Vss electrostatic discharge bus is connected to the Vss power source bus. The region above the forth metal layer 34 is not electrically connected to the bottom portion of the closed ring structure, so the region can be the Vdd electrostatic discharge bus. The Vdd electrostatic discharge bus is connected to the Vdd power source bus. All the metal layers, which are formed between the Vss electrostatic discharge bus and the Vdd electrostatic discharge bus, are disposed in the different layers. The Vss electrostatic discharge bus and the Vdd electrostatic discharge bus is electrically isolated to each other. Therefore, the structure of the present embodiment can be used by the Vss electrostatic discharge bus and the Vdd electrostatic discharge bus at the same time.

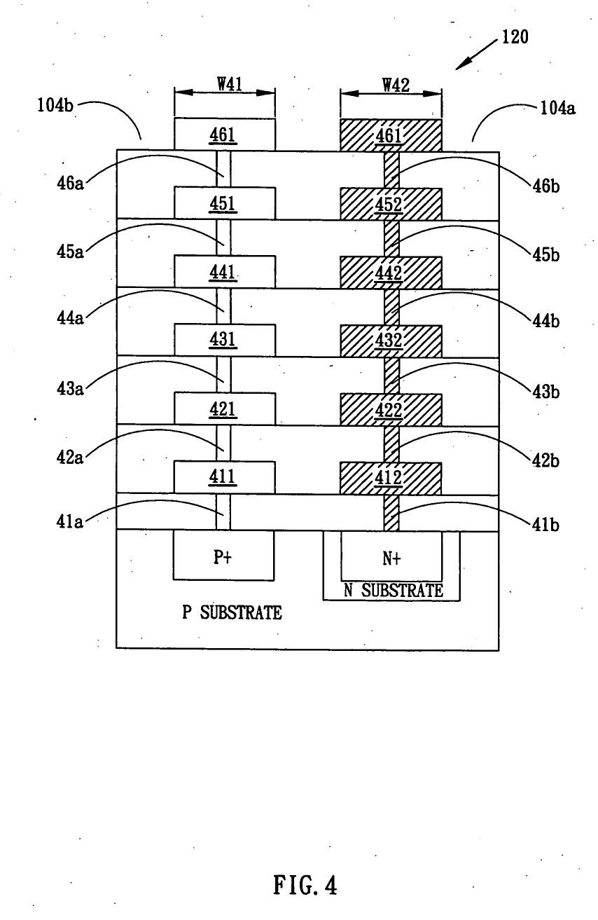

FIG. 4 is the closed ring structure according to the second embodiment of the present invention. Comparing FIG. 4 with FIG. 1A, the closed ring 120 includes a metal region 411 and a metal region 412 of the first metal layer, a metal region 421 and a metal region 422 of the second metal layer, a metal region 431 and a metal region 432 of the third metal layer, a metal region 441 and a metal region 442 of the forth metal layer, a metal region 451 and a metal region 452 of the fifth metal layer, a metal region 461 and a metal region 462 of the sixth metal layer. And all the metal layers are isolated to each other by the oxidized layer. The right side of the metal region 462 is the oxidized surface 104a of the first circle, and the left side of which is the oxidized surface 104b of the second circle. The bottom of the closed ring 120 is the P substrate. The P substrate includes two doped regions. The left side of the doped region is the P+ substrate, and the right side of the doped region is the N well and the N+ substrate contact. The conductive properties of these two doped regions are different.

The metal region 411 of the first metal layer is electrically connected to the P+ substrate contact by the conductive contact 41a. The metal region 411 of the first metal layer is electrically connected to the metal region 421 of the second metal layer by the conductive plug 42a. The metal region 421 of the second metal layer is electrically connected to the metal region 431 of the third metal layer by the conductive plug 43a. The metal region 431 of the third metal layer is electrically connected to the metal region 441 of the forth metal layer by the conductive plug 44a. The metal region 441 of the forth metal layer is electrically connected to the metal region 451 of the fifth metal layer by the conductive plug 45a. The metal region 451 of the fifth metal layer is electrically connected to the metal region 461 of the sixth metal layer by the conductive plug 46a.

The metal region 412 of the first metal layer is electrically connected to the N+ substrate contact by the conductive contact 41b. The metal region 412 of the first metal layer is electrically connected to the metal region 422 of the second metal layer by the conductive plug 42b. The metal region 422 of the second metal layer is electrically connected to the metal region 432 of the third metal layer by the conductive plug 43b. The metal region 432 of the third metal layer is electrically connected to the metal region 442 of the forth metal layer by the conductive plug 44b. The metal region 442 of the forth metal layer is electrically connected to the metal region 452 of the fifth metal layer by the conductive plug 45b. The metal region 452 of the fifth metal layer is electrically connected to the metal region 462 of the sixth metal layer by the conductive plug 46b.

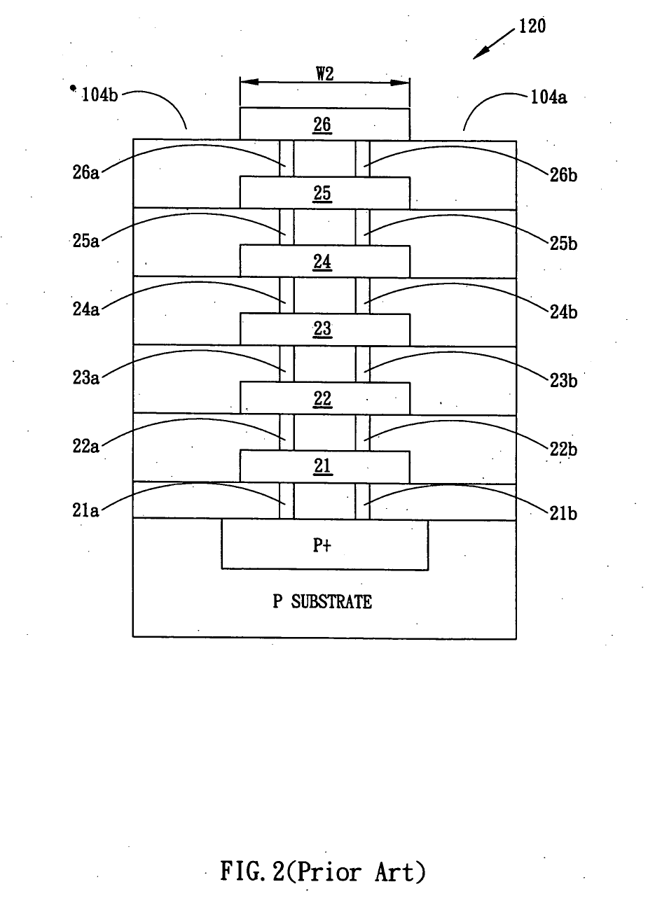

To compare FIG. 4 with FIG. 2, the structure of FIG. 4 is that the structure of FIG. 2 is divided into two closed ring region by the oxidized layer. The width W41 of the left side of the closed ring region or the width W42 of the right side of the closed ring region is about haft of the width of the closed ring region in FIG. 2. The left structure of the closed ring region is not electrically connected to the right structure of the closed ring region. Therefore, the left side of the closed ring structure is Vss electrostatic discharge bus. The Vss electrostatic discharge bus is electrically connected to the Vss power source bus. The right side of the closed ring structure is the Vdd electrostatic discharge bus and the slide line is drawn in the Vdd electrostatic discharge bus region. The Vdd electrostatic discharge bus is electrically connected to Vdd power source bus. The Vdd electrostatic discharge bus is disposed near the Vss electrostatic discharge bus and is electrically isolated to each other. Therefore, the structure of the present embodiment can be used by the Vss electrostatic discharge bus and the Vdd electrostatic discharge bus at the same time.

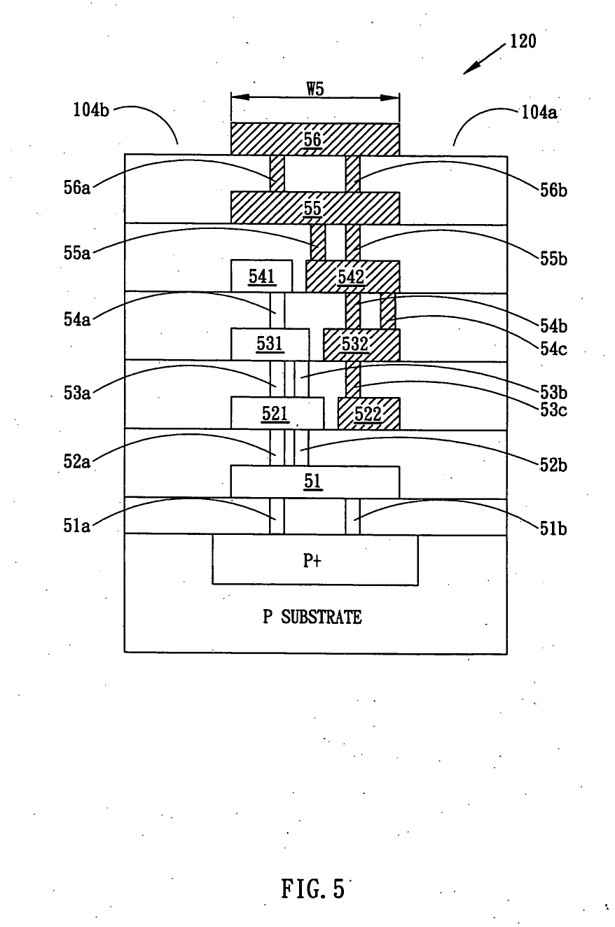

FIG. 5 is the cross-sectional view according to the closed ring structure of the third embodiment of the present invention. And comparing FIG. 5′ with FIG. 1A, the closed ring 120 includes a first metal layer 51, a metal region 521 and a metal region 522 of the second metal layer, a metal region 531 and a metal region 532 of the third metal layer, a metal region 541 and a metal region 542 of the forth metal layer, a fifth metal layer 55 and a sixth metal layer 56. The right side of the sixth metal layer is the oxidized surface 104a of the first circle and the left side of which is the oxidized surface of the second circle 104b. The bottom of the closed ring is a P substrate. The P substrate includes a doped region, which is a P+ substrate contact.

The first metal layer 51 is electrically connected to P+ substrate contact by the conductive contact 51a and the conductive contact 51b. The first metal layer 51 is electrically connected to the metal region 521 of the second metal layer by the conductive plug 52a and the conductive plug 52b. The metal region 521 of the second metal layer is electrically connected to the metal region 531 of the third metal layer by the conductive plug 53a and the conductive plug 53b. The metal region 531 of the third metal layer is electrically connected to the metal region 541 of the forth metal layer by the conductive plug 54a. The metal region 522 of the second metal layer is electrically connected to the metal region 532 of the third metal layer by the conductive plug 53c. The metal region 532 of the third metal layer is electrically connected to the metal region 542 of the forth metal layer by the conductive plug 54b and 54c. The metal region 542 of the forth metal layer is electrically connected to the fifth metal layer 55 by the conductive plug 54b. The forth metal layer 54 is electrically connected to the fifth metal layer 55 by the conductive plug 55a and 55b. The fifth metal layer 55 is electrically connected to the sixth metal layer 56 by the conductive plug 56a and 56b.

To compare the closed ring in FIG. 3 and FIG. 5, the structure in FIG. 5 is that the closed ring is divided into the bottom left portion and top right portion. This structure is more complicated than the structure in FIG. 3 and FIG. 4. The bottom left portion of the closed ring structure is not electrically connected to the top right portion of the closed ring structure. Therefore, the bottom left portion of the closed ring structure is the Vss electrostatic discharge bus and the top right portion of the closed ring structure is the Vdd electrostatic discharge bus. The Vdd electrostatic discharge bus is electrically connected to the Vdd power source bus. Therefore, the structure of the present embodiment can be used by the Vss electrostatic discharge bus and the Vdd electrostatic discharge bus at the same time. And comparing to the FIG. 3, the oxidized layer divided from the closed ring 120 is irregular in the present embodiment. The Vss electrostatic discharge bus and the Vdd electrostatic discharge bus are formed in the step shape by the cross-sectional view. The positions of these two step shapes are complementary to each other and the mechanism strength can be enhanced in the parallel and vertical direction of the die. So the structure of the present embodiment is harder than the structure in FIG. 3.

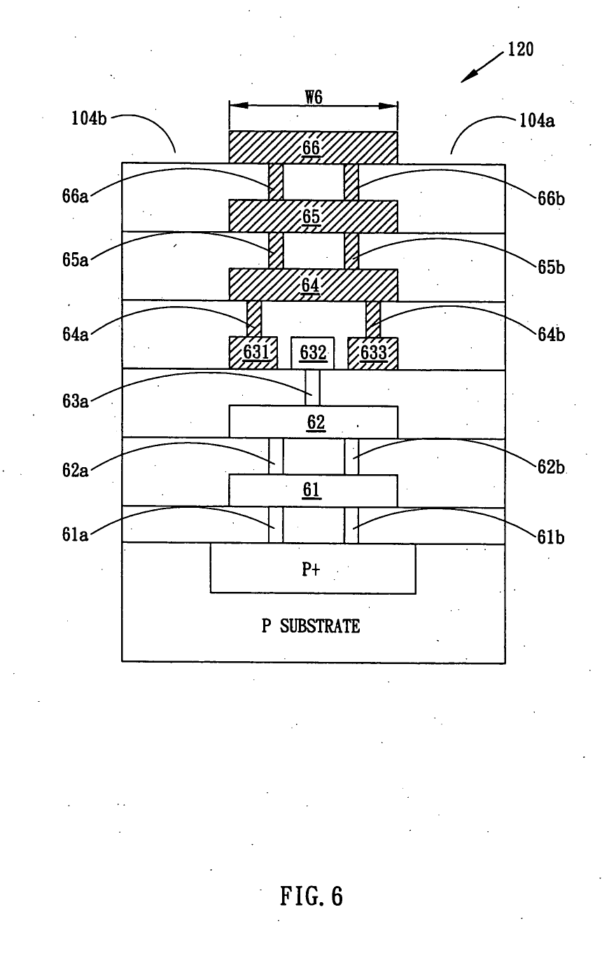

FIG. 6 is the cross-sectional view according to the closed ring structure of the forth embodiment in the present invention. The closed ring 120 includes a first metal layer 61, a second metal layer 62, a metal-region 631, a metal region 632 and a metal region 633 of the third metal layer, a forth metal layer 64, a fifth metal layer 64, and a sixth metal layer 66. All the metal layers are isolated to each other by the oxidized layer. The right side of the sixth metal layer 66 is the oxidized layer 104a of the first circle and the left side of which is the oxidized layer 104b of the second circle. The bottom of the closed ring is a P substrate. The P substrate includes a doped region, which is a P+ substrate contact.

The first metal layer 61 is electrically connected to the P+ substrate by the conductive contact 61a and conductive contact 61b. The first metal layer 61 is electrically connected to the second metal layer 62 by the conductive plug 62a and the conductive plug 62b. The second metal layer 62 is electrically connected to the metal region 632 of the third metal layer by the conductive plug 63a. The metal region 631 of the third metal layer is electrically connected to the forth metal layer 64 by the conductive plug 64a. The metal region 633 of the third metal layer is electrically connected to the metal layer 64 by the conductive plug 64b. The forth metal layer 64 is electrically connected to the fifth metal layer 65 by the conductive plug 65a and the conductive plug 65b. The fifth metal layer 65 is electrically connected to the sixth metal layer 66 by the conductive plug 66a and the conductive plug 66b.

By comparing FIG. 6 with FIG. 3, the structure of FIG. 6 is the closed ring divided into the top portion and the bottom portion by the oxidized layer. The top portion of the closed ring region is not electrically connected to the bottom portion of the closed ring region. But the structure of the present embodiment is more complicated than the structure in FIG. 3. The bottom portion of the closed ring structure is the Vss electrostatic discharge bus and the Vss electrostatic discharge bus is electrically connected to the Vss power source bus. The top portion of the closed ring structure is the Vdd electrostatic discharge bus and the Vdd electrostatic discharge bus is drawn by the slide line. The Vdd electrostatic discharge bus is electrically connected to the Vdd power source bus. Therefore, the structure of the present embodiment can be used by the Vss electrostatic discharge bus and the Vdd electrostatic discharge bus at the same time. By comparing to FIG. 3, the closed ring structure is isolated by the oxidized layer and the shape of the oxidized layer is irregular. So the structure of the present embodiment is harder than the structure in FIG. 3.

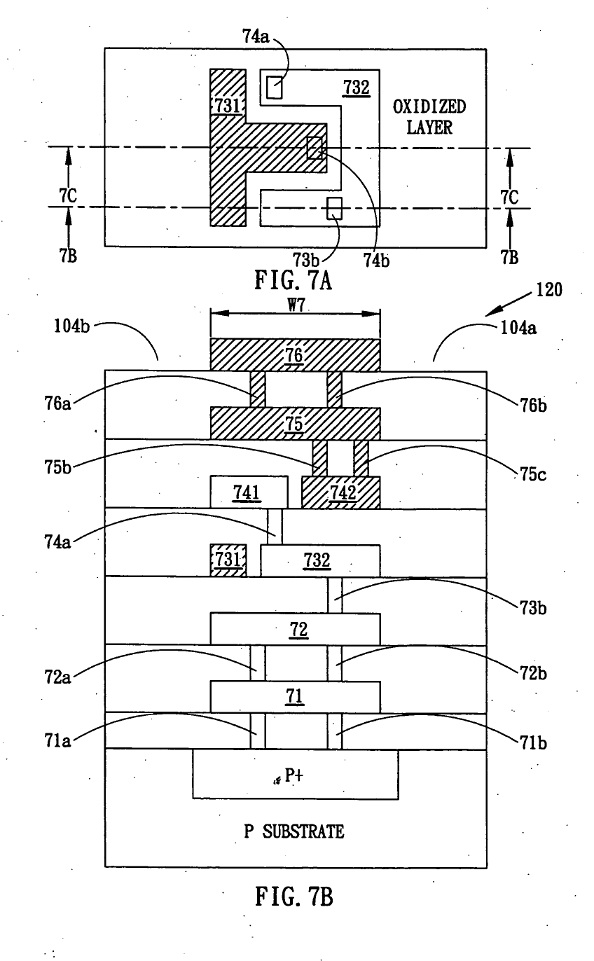

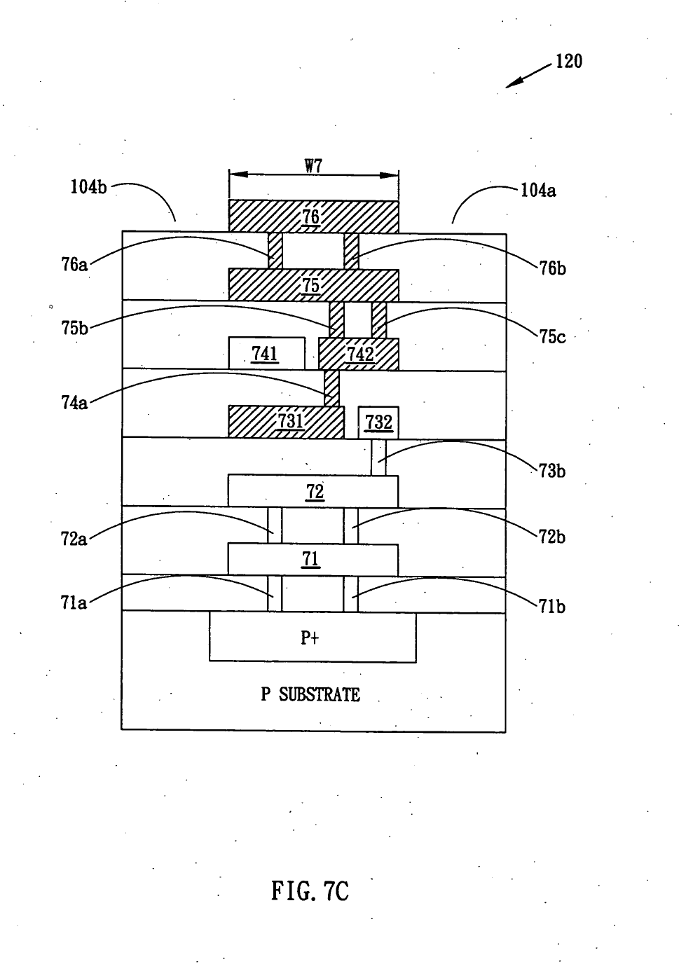

FIG. 7A is the cross-sectional view according to the third metal layer of the fifth embodiment in the present invention. The third metal layer is divided by the oxidized layer into two metal regions 731 and 732, which are not electrically connected to each other. And the metal region 731 and the metal region 732 are like a concave connected to a protruding. There are three conductive plugs 73b, 74a and 74b. FIG. 7A is divided into FIG. 7B and FIG. 7C by the cross-sectional line 7B and 7C. FIG. 7B is the first cross-sectional view according to the closed ring structure of the fifth embodiment in the present invention. By comparing FIG. 7B with FIG. 1A, the closed ring 120 includes a first metal layer 71, a second metal layer 72, a metal region 731 and a metal region 732 of the third metal layer, a metal region 741 and a metal region 742 of the forth metal layer, a fifth metal layer 74 and a sixth metal layer 76. All the metal layers are isolated to each other by the oxidized layer. The right side of the sixth metal layer 76 is the oxidized surface 104a of the first circle and the left side of which is the oxidized surface 104b of the second circle. The bottom of the closed ring 120 is a P substrate, which includes a P+ substrate contact.

The first metal layer 71 is electrically connected to the P+ substrate contact by the conductive contact 71a and the conductive contact 71b. The first metal layer 71 is electrically connected to the second metal layer 72 by the conductive plug 72a and the conductive plug 72b. The second metal layer 72 is electrically connected to the metal region 732 of the third metal layer by the conductive plug 73b. The metal region 732 of the third metal layer is electrically connected to the metal region 741 of the forth metal layer by the conductive plug 74a. The metal region 742 of the forth metal layer is electrically connected to the fifth metal layer 75 by the conductive plug 75b and the conductive plug 75c. The fifth metal layer 75 is electrically connected to the sixth metal layer 76 by the conductive plug 76a and the conductive plug 76b.

By comparing FIG. 7B with FIG. 3, FIG. 4, FIG. 5, FIG. 6, the closed ring structure of FIG. 7B is divided by the oxidized layer into the top portion and the bottom portion. The top portion and the bottom portion of the closed ring structure are isolated to each other. Therefore, the bottom portion of the closed ring structure can be used by a Vss electrostatic discharge bus and the Vss electrostatic discharge bus is electrically connected to the Vss power source bus. The top portion of the closed ring structure can be used by a Vdd electrostatic discharge bus and the Vdd electrostatic discharge bus is drawn by the slide line. The Vdd electrostatic discharge bus is electrically connected to the Vdd power source bus. Therefore, the structure of the present embodiment can be used by the Vss electrostatic discharge bus and the Vdd electrostatic discharge bus at the same time.

FIG. 7C is the second cross-sectional view according to the closed ring structure of the fifth embodiment in the present invention. By comparing to FIG. 1A, the closed ring 120 includes a first metal layer 71, a second metal layer 72, a metal region 731 and a metal region 732 of the third metal layer, a metal region 741 and a metal region 742 of the forth metal layer, a fifth metal layer 75, and a sixth metal layer 76. All the metal layers are isolated to each other by the oxidized layer. The right side of the sixth metal layer 76 is the oxidized surface 104a of the first circle and the left side of which is the oxidized surface 104b of the second circle. The bottom of the closed ring 120 is a P substrate. The P substrate includes a doped region, which is a P+ substrate contact.

The first metal layer 71 is electrically connected to the P+ substrate by the conductive contact 71a and conductive contact 71b. The first metal layer 71 is electrically connected to the second metal layer 72 by the conductive plug 72A and the conductive plug 72b. The second metal layer 72 is electrically connected to the metal region 731 of the third metal layer by the conductive plug 73b. The metal region 731 of the third metal layer is electrically connected to the metal region 741 of the forth metal layer by the conductive plug 74B. The metal region 742 of the forth metal layer is electrically connected to the fifth metal layer 75 by the conductive plug 75b and the conductive plug 75c. The fifth metal layer 75 is electrically connected to the sixth metal layer 76 by the conductive plug 76A and the conductive plug 76b.

By comparing FIG. 7C with FIG. 3, FIG. 4, FIG. 5, and FIG. 6, the closed ring structure in FIG. 7A is divided into the top portion and the bottom portion by the oxidized layer. The top portion and the bottom portion of the closed ring structure are not electrically connected to each other. Therefore, the bottom portion of the closed ring structure is used to be the Vss electrostatic discharge bus. The Vss electrostatic discharge bus is electrically connected to Vss power source bus. The top portion of the closed ring structure is used to be the Vdd electrostatic discharge bus and the Vdd electrostatic discharge bus is electrically connected to the Vdd power source bus. Therefore, the structure in the present embodiment can be used by the Vss electrostatic discharge bus and the Vdd electrostatic discharge bus. But the structures in FIG. 7A, FIG. 7B and FIG. 7C are more complicated than the structure in FIG. 3, FIG. 4, FIG. 5 and FIG. 6. The structure of the oxidized layer electrically isolates these two closed ring structures in the present embodiment is more irregular than the structure in FIG. 3, FIG. 4, FIG. 5 and FIG. 6. The conductive plugs are crossly disposed, so the strength of the 3 dimension can be enhanced. The structures of the embodiments in FIG. 7A, FIG. 7B, and FIG. 7C is harder than the structures in FIG. 3, FIG. 4, FIG. 5 and FIG. 6.

It should be noted that the closed ring structure of the present invention is not always like the sealed ring structure in FIG. 1A. The closed ring structure of the present invention can be a non-sealed ring structure or the structure can be used to form an electrostatic discharge bus shown in the present invention.

Although specific embodiments have been illustrated and described, it will be appreciated by those skilled in the art that various modifications may be made without departing from the scope of the present invention, which is intended to be limited solely by the appended claims.

What is claimed is:

1. A closed ring structure of the electrostatic discharge circuitry, comprising:
a first electrostatic discharge structure disposed near an edge of a die and electrically connected to a power source structure, said first electrostatic discharge structure including a plurality of first conductive layers; and
a second electrostatic discharge structure disposed near said first electrostatic discharge structure and electrically isolated to said first electrostatic discharge structure, and said second electrostatic discharge structure electrically connected to a second power source structure, said second electrostatic discharge structure including a plurality of second conductive layers.

2. The closed ring structure of the electrostatic discharge circuitry of claim 1, wherein said first electrostatic discharge structure is a Vss electrostatic discharge bus and said first power source structure is a Vss power source bus.

3. The closed ring structure of the electrostatic discharge circuitry of claim 2, wherein said second electrostatic discharge structure is a Vdd electrostatic discharge bus and said second power source structure is a Vdd power source bus.

4. The closed ring structure of the electrostatic discharge circuitry of claim 1, wherein said first electrostatic discharge structure or said second discharge structure is a closed ring structure in said die.

5. The closed ring structure of the electrostatic discharge circuitry of claim 1, wherein said first electrostatic discharge structure or said second discharge structure is a non-closed ring structure in said die.

6. The closed ring structure of the electrostatic discharge circuitry of claim 1, wherein said second electrostatic discharge structure is disposed on the top of said first electrostatic discharge structure.

7. The closed ring structure of the electrostatic discharge circuitry of claim 6, wherein said first electrostatic discharge structure is electrically connected to a doped region of a substrate in said die.

8. The closed ring structure of the electrostatic discharge circuitry of claim 6, wherein between said first electrostatic discharge structure and said second discharge structure, all the first conductive layer and the second conductive layer are disposed in different level.

9. The closed ring structure of the electrostatic discharge circuitry of claim 6, in said first conductive layers of said first electrostatic discharge structure and said second conductive layers of said second electrostatic discharge structure, there are a first conductive layer and a second conductive layer disposed in the same level.

10. The closed ring structure of the electrostatic discharge circuitry of claim 9, wherein said first conductive layer in the top of the first electrostatic structure and said second conductive layer in the bottom of the second electrostatic structure are in the same level.

11. The closed ring structure of the electrostatic discharge circuitry of claim 6, wherein some of said first conductive layer in said first electrostatic discharge structure and some of said second conductive layer in said second electrostatic discharge structure are disposed in the same level.

12. The closed ring structure of the electrostatic discharge circuitry of claim 11, wherein the cross-sectional view of said first electrostatic discharge structure and said second electrostatic discharge structure is a step shape, and said first electrostatic discharge structure and said second electrostatic discharge structure are complementary to each other.

13. The closed ring structure of the electrostatic discharge circuitry of claim 11, wherein one of said first conductive layer in said first electrostatic discharge structure and one of said second conductive layer in said second electrostatic discharge structure are in the same level and are formed concave and protruding shape in the cross-sectional view.

14. The closed ring structure of the electrostatic discharge circuitry of claim 13, wherein at least one first conductive layer and a second conductive layer is in the same level, and crossly connected to each other by a conductive plug.

15. The closed ring structure of the electrostatic discharge circuitry of claim 1, wherein said second electrostatic discharge structure is disposed in the top of said first electrostatic discharge structure, and the width of said first electrostatic discharge structure or said second electrostatic discharge structure is about 4 μm to 40 μm.

16. The closed ring structure of the electrostatic discharge circuitry of claim 1, wherein said second electrostatic discharge structure is disposed near said first electrostatic discharge structure.

17. The closed ring structure of the electrostatic discharge circuitry of claim 16, wherein said first electrostatic discharge structure is electrically connected to a doped region of a substrate in said die, and said second electrostatic discharge structure is electrically connected to another doped region of said substrate in said die and both of said doped regions have opposite electrode.

18. The closed ring structure of the electrostatic discharge circuitry of claim 1, wherein said second electrostatic discharge structure is near said first electrostatic discharge structure, and the width of said first electrostatic discharge structure or said second electrostatic discharge structure is about 4 μm to 40 μm.

19. The closed ring structure of the electrostatic discharge circuitry of claim 1, a dielectric is formed between each of said first conductive layers and each of said second conductive layers.

20. The closed ring structure of the electrostatic discharge circuitry of claim 19, at least one conductive plug is passed through said dielectric between the top and the bottom of said first conductive layer and between the top and the bottom of said second conductive layer, and the top and bottom of said first conductive layer are electrically connected to the top and bottom of said second conductive layer.
